(19) United States
(12) Patent Application Publication
(10) Pub. No.: US 2009/0172427 A1
(43) Pub. Date: Jul. 2, 2009

(54) Method and system for power management of a motherboard

(75) Inventors: Hou-Yuan Lin, Taipei (TW); Chen-Shun Chen, Taipei (TW)

Correspondence Address: BIRCH STEWART KOLASCH & BIRCH, PO BOX 747, FALLS CHURCH, VA, 22040-0747, US

(73) Assignee: GIGABYTE UNION INC. & GIGA-BYTE TECHNOLOGY CO., LTD.

(21) Appl. No.: 12/153,767

(22) Filed: May 23, 2008

(30) Foreign Application Priority Data
Dec. 31, 2007 (TW) 096151625

(51) Int. Cl. G06F 1/26

(52) U.S. Cl. 713/300

(57) ABSTRACT

A method for power management of a motherboard is provided to manage a power supply on the motherboard and specially to manage an output power of a power management module on the mother board. The motherboard at least comprises a microprocessor, and the power management module provides a power with a number of output phases to the microprocessor. First, a first load of the microprocessor is detected in a first time. Then a second load of the microprocessor in a second time is detected. When the second load is less than the first load and is lower than a first predetermined value, the number of output phases of the power outputted from the power management module is reduced.

### CROSS-REFERENCE TO RELATED APPLICATIONS

This nonprovisional application claims priority under 35 U.S.C. §119(a) on Patent Application No. 096151625, filed in Taiwan on Dec. 31, 2007, the entirety of which is incorporated herein by reference.

### BACKGROUND OF THE INVENTION

1. Field of the Invention

The present invention relates to a system of power management, and more particularly, to a system of power management of a computer motherboard.

2. Background of the Invention

A motherboard is one of the most important components of a computer and it is the core to operate the computer system. A CPU, a fan for the CPU, chipsets, a BIOS, memories and expansion slots for interface cards etc., which are necessary for the computer operation, are all set on the motherboard.

When a CPU operates, it will temporarily store data in a memory first. Therefore, the larger the capability of the memory is, the more work the computer can simultaneously process and the rapider the process is. Moreover, the interface card is a communication bridge between a host and peripheral devices such as a screen, and the different functions interface cards, e.g., a sound card, a network card, a 3D game accelerating card, etc., can be inserted into the motherboard to expand the functions of the computer. The display card is an important interface card for the computer. Without the display card, no image will be displayed on the screen. In addition, without the sound card, music or other sound files in the computer may only be played through the audio components of the host.

The operation of the above-mentioned devices all depend on the electric power supplied by the power source. The power supply module can be built in the motherboard and also can be on a card. When the power supply module uses is built in the motherboard, the electrical resistance of the power supply module is at its minimum and the power supply module does not need the conversion of the interface card slot. Therefore, the signal can be transmitted rapidly and would not attenuate easily. On the other hand, when the power supply module is on a card, the card can be replaced when it is destroyed. In general, the majority of current motherboards use the built-in design.

When the CPU is operated in a high frequency or high load condition, more stabilized electrical source is needed for the motherboard. Multi-phase PWM power supply module is used to provide the sustained and steady power supply in the condition of high frequency and high load. Since the demand for power sources with more stability voltage and electric current is continuously increasing, the phase number of the PWM power supply module for the core power supply needed by the CPU will increase.

The phase here can be described by the composition of one-phase power supply. The single-phase power supply mainly comprises a PWM (Pulse width Modulation) power control chip, a set of high side or low side MOSFET (Metal Oxide Semiconductor Field Effect Transistor), a CHOKE and several capacitances. Generally, the amperage provided by a single-phase circuit is limited. Since more and more power consumption is needed for the processor and the display card, the three-phase power supply design has already been the basic design of the motherboard.

Multi-phase power supply is comprised of N single-phase electric circuits in parallel. The multi-phase electric source can provide N times of the electric current of a single-phase electric circuit. The PWM power control chip mainly accurately controls and balances each phase electric source through. The more phase number, the closer to the direct current the output electric current is. Of course the more phase number of the power supply module for motherboard, the better it is. Because the total electric power can be distributed to each phase to load all together, the current loaded for each set of MOSFET for each phase becomes smaller and the calorific value also relatively decreases, which effectively increases the heat-dissipating efficiency of the power supply module for the motherboard. The main effect of High Side or Low Side MOSFET is to provide a flowing channel of the current when switching. The larger the amount of current, the hotter the MOSFET is. Therefore, most of the MOSFET is covered by a radiating fin.

However, the present multi-phase power supply cannot regulate according to the load. That is to say, no matter what the load of the present CPU is, the number of output phases of the power supply outputted from the PWM power control chip is fixed.

### SUMMARY OF THE INVENTION

The present invention discloses a method for power management of a motherboard. Therefore, the output phase number of the power supply can be adjusted according to the actual load to reduce the whole power consumption of the system.

In one aspect of the present invention, a method for power management of a motherboard is provided to manage a power supply on the motherboard and specially to manage an output power of a power management module on the motherboard. The motherboard at least comprises a microprocessor, and the power management module provides a power supply having several output phases to the microprocessor. First, a first load of the microprocessor is detected in a first time. Then a second load of the microprocessor in a second time is detected. When the second load is less than the first load and is lower than a first predetermined value, the number of output phases of the power outputted from the power management module is reduced.

The method for power management as embodied can detect the current load of the system to adapt the power output phrases needed by the system, and shut off the power supply of the unused devices to achieve the power saving goal.

The method and system for power management of the present invention can be implemented via hardware devices and/or software to detect the load used by the system on a real-time basis. The method and system can be applied to the current motherboards. The method and system can also be implemented via software and hardware control line to change the voltages and operation frequencies of CPU, memory, and PCI_EXPRESS display card synchronously according to the load of the system. The method for power management can change the voltage and frequency of the devices from high to low. That is, when the load is high, the largest output phase number of power supply is returned to operate, and when the load is low, the voltage and frequency of the devices of the system are decreased to reduce power consumption. The method for power management detects the load of the system on a real-time basis. Therefore, when the system is on a higher/lower load, the voltage and frequency are raised/reduced in a short time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic block diagram of a motherboard according to an embodiment of the present invention; and

FIG. 2 is a flow chart for a method of power management according to an embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

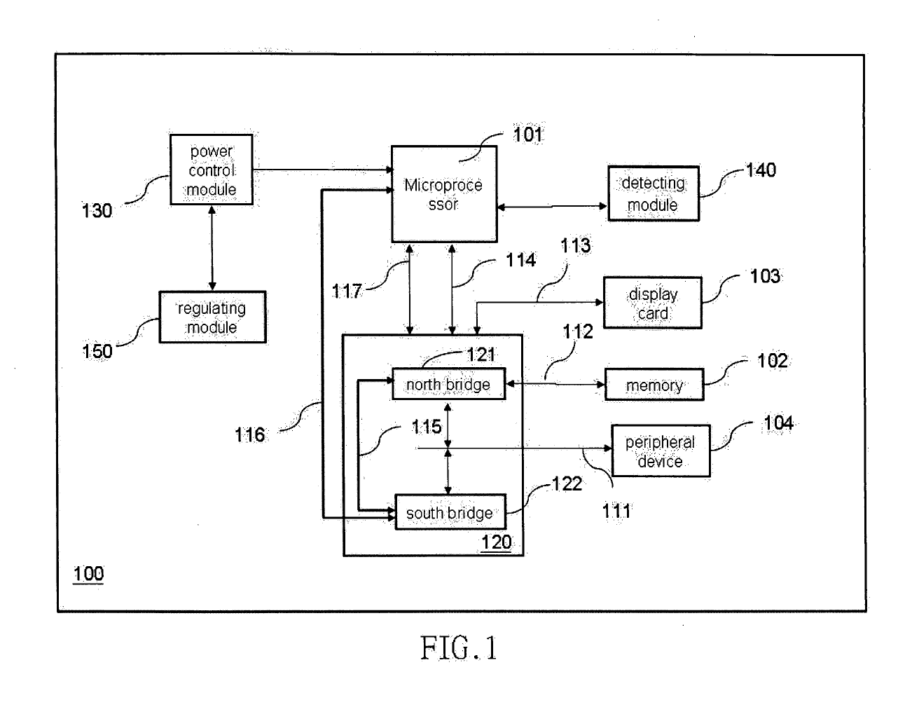

FIG. 1 is a schematic block diagram of a motherboard 100 according to an embodiment of the present invention.

Generally, a motherboard 100 has a microprocessor 101. Most of the tasks, interrupting handling or events all need to be processed through the microprocessor 101. The motherboard 100 comprises a microprocessor slot for inserting the microprocessor 101, a BIOS, a memory slot for inserting memory 102, a PCI bus 11 1, a memory bus 112, a PCI-EXPRESS bus 113 and other expansion slots and buses. The above-mentioned buses are used only for the illustration purposes, not to limit the type of the motherboard applied in the present invention. Of course, other buses such as AGP bus or other buses known in the art can be included.

In order to control all of the peripheral components on the motherboard 100, a system control chipset 120 is disposed on the motherboard 100. The system control chipset 120 has different functions designs according to different motherboard structures. In a general motherboard, the system control chipset 120 comprises a north bridge 121 and a south bridge 122. The north bridge 121 is responsible for the signal transmission and communication between the memory 102 and the display card 103 on the PCI_EXPRESS bus interface and the signal transmission and communication between the memory 102 and the microprocessor 101. The south bridge 122 is responsible for the communication among the PCI peripheral device, the hard disk, the software, the mouse, etc. and the microprocessor 101.

The microprocessor 101 communicates with the north bridge 121 through the system bus 114. However the signal communication and the control instructions transmission between the south bridge 122 and the north bridge 121, between the south bridge 122 and the microprocessor 101, and between the north bridge 121 and the microprocessor 101 are respectively accomplished through the signal line 115, 116 and 117.

Since the operating frequency of the present microprocessor 101 becomes higher and higher, the motherboard 100 further includes a power control module 130 to provide multi-phase power supply output with frequency adaptation. The power control module 130 provides a multi-phase power supply for the microprocessor 101 to make the microprocessor 101 operate steadily at high frequency. The power control module 130 can output the power supply of four phases, six phases and eight phases. Some high-end models even output the power supply of twelve phases or more.

Although the power control module 130 can be implemented as a circuit, it also can be selectively realized via some commercial integrated circuits such as Model No. ISL6327 sold by Intersil Corporation.

The conventional power control module 130 can output multi-phase power supply, but the number of the phases cannot be adapted according to the load of present system. That is to say, if the power control module 130 can provide six-phase power, no matter whether the load of the microprocessor 101 is high or low, the power control module 130 is always output with six-phase power. Therefore, if the output phase of the power control module 130 can be decreased in the condition of low load, the consumption of the power supply can be decreased to reduce the power consumption.

The motherboard 100 also includes a detecting module 140 to detect a first load of the microprocessor in a first time and detect a second load of the microprocessor in a second time. In addition, the motherboard comprises a regulating module 150 to reduce the number of the output phases of the power supply outputted from the power management module, when the second load is less than the first load and lower than the first predetermined value. The detecting module 140 can be implemented by an independent circuit in one embodiment, and the detecting module 140 can also be implemented by a firmware in the microprocessor. The regulating module 150 can be implemented by an independent circuit in one embodiment and also can be implemented by the combination use of firmware and software.

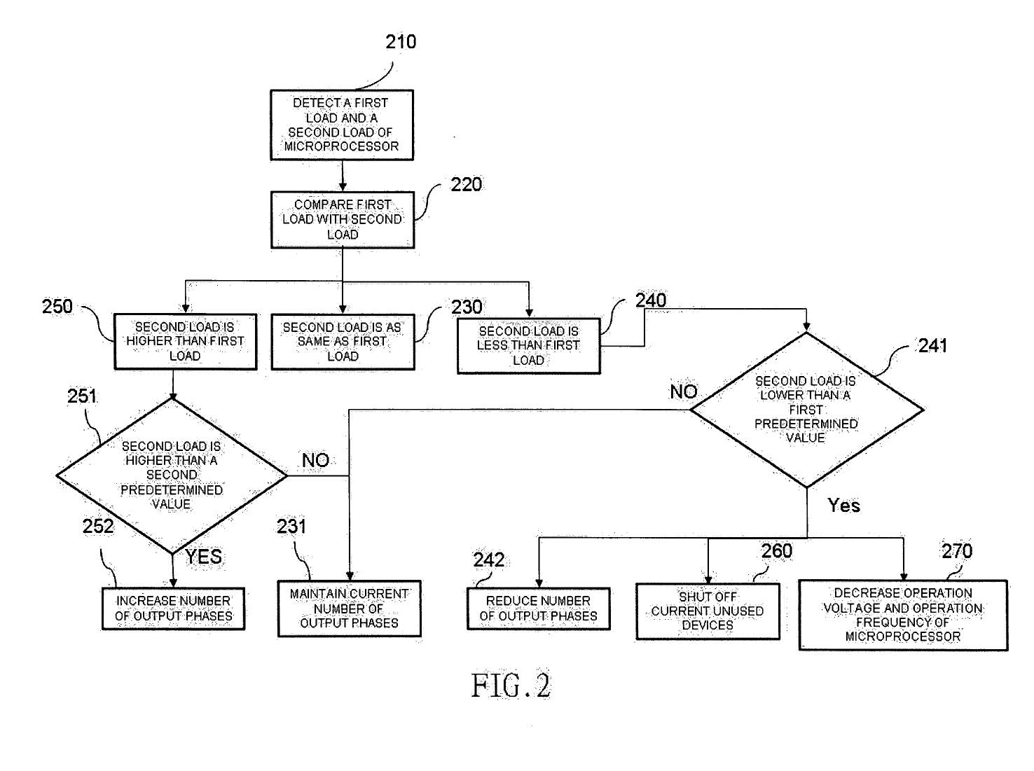

FIG. 2 is a flow chart for a method of power management according to an embodiment of the present invention. The method can auxiliary and dynamically adapt the power supply. According to the method, the power supply is managed through the computer software that is executed by the microprocessor and is also processed by the power management module. All hardware adapting/adjusting the output phase of the power control module 130 can apply the computer software program to process in TSR (Terminate and Stay Resident) method or other methods to achieve the goal to regulate the output phase.

When the north bridge 121, the south bridge 122, the display card 103, the memory 102 and/or other peripheral devices 104 operate, the microprocessor will be in a high load condition. In fact, the load condition is classed with each load classification corresponding to an output phase. If a full load is set as 100%, the situation of the load is selectively classed into five grades. The first grade load is 20%, the second grade load is 40%, the third grade load is 60%, the forth grade load is 80% and the fifth grade load is 100%. Taking the six-phase power supply as an example, when the load is in the first grade, the two-phase output power supply can be used. When the load is in the second grade, the three-phase output power supply can be used. When the load is in the third grade, the fourth-phases output power supply can be used. When the load is in the fourth grade, the fifth-phases output power supply can be used. When the load is in the fifth grade, the sixth-phases output power supply can be used.

The classification of the load can be determined according to the number of the output phase of the power control module 130. The load condition is classed into three grades in another embodiment. The first grade load is 33%, the second grade load is 66% and the third grade load is 100%. Taking the three-phase output as an example, when the load is in the first grade, the one-phase output power supply can be used. When the load is in the second grade, the two-phase output power supply can be used. When the load is in the third grade, the three-phase output power supply can be used.

A first load of the microprocessor is detected in a first time when the system operates (step 210), and the first load is recorded. Then a second load of the microprocessor is detected in a second time and the second load is also recorded. The interval between the first time and the second time can be regulated according to the actual condition. If the power supply output needs to be dynamically regulated in real-time, the interval between the first time and the second time can be set shorter.

Thereafter, the first load is compared with the second load to judge whether the load of the microprocessor is changed (step 220). When the second load detected in the second time is as the same as the first load detected in the first time (step 230), it shows that the load of the present system is not change. The power management module 130 then can maintain the current number of output phases (step 231) and keep outputting the same power to the microprocessor.

When the second load is less than the first load (step 240) but is not lower than the first predetermined value, such as the above-mentioned third load or second load, the power management module 130 continues to output power supply with current number of output phases (step 231). If the second load is lower than the first predetermined value (step 241), the power management module 130 reduces the number of the output phases (step 242) and outputs the power supply with decreased phase number to the microprocessor.

If the second load is higher than the first load (step 250) abut is still lower than the predetermined value (step 251), such as the above-mentioned second load and the third load, the power management module 130 continues to output power supply with current number of output phases (step 231). If the second load is higher than a second predetermined value (step 251), the power management module 130 increases the number of the output phases (step 252) and outputs the power supply with increased phase number to the microprocessor (step 242).

In addition to changing the phase number of the output power supply, in another embodiment, the operation frequency of the power management module can be decreased to decrease the output power consumption (step 270).

Furthermore, the unused devices can be shut off according to the load (step 260). When the load of the microprocessor is detected, the device which is not on service is also detected at the same time. For example, when the south bridge is not on service and the second load is lower than a predetermined value, a GPIO PIN switching line is provided to decrease the output of the power supply through the power source line and reduce the output of the power supply to the south bridge 122. The power supply will return to normal immediately when it is needed. If there are external GSATA and LAN chips, the GPIO control line can also be added to the independent power supply line. Therefore, when the output of the power supply is detected to be unused yet, the GPIO control line shuts off the power supply temporarily by sending out a shutting off signal immediately. When the reading operation is needed, the power supply will return to normal through the GPIO control line by sending out an open signal.

In the embodiment, when the system operates and the load of the system is lower, the output of the power supply will be decreased through the GPIO PIN switching line to shut off the unneeded device, and the voltage will return to normal supply immediately when it is needed.

In another embodiment, if the second load is lower than the first load and is lower than a determined value (step 241), the power management module 130 decreases the operation voltage and frequency of the microprocessor in addition to decreasing the output phase (step 270). The power management module 130 can also decrease the operation voltage and the operation frequency of memory, South bridge chipset, North bridge chipset, display card, etc.

The power management module can adapt the power output phase according to the load of microprocessor through detecting the load of the microprocessor In addition, since the system detects the load continuously on a real-time basis, the system can regulate itself according to the actual load condition. If there is any change of the load, the phase number of the power supply will be adapted immediately. Therefore, the whole power consumption of the system will be reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for power management of a motherboard, the motherboard at least comprising a microprocessor and a power management module, the power management module providing a power with a number of output phases to the microprocessor, the method comprising:
detecting a first load of the microprocessor in a first time;
detecting a second load of the microprocessor in a second time; and
reducing the number of output phases of the power outputted from the power management module when the second load is less than the first load and is lower than a first predetermined value.

2. The method of claim 1, further comprising maintaining a current number of output phases of the power outputted from the power management module when the second load is less than the first load and is higher than the first predetermined value.

3. The method of claim, 1 further comprising maintaining a current number of output phases of the power outputted from the power management module when the second load is same as the first load.

4. The method of claim 1, further comprising increasing the number of output phases of the power outputted from the power management module when the second load is higher than the first load and is higher than a second predetermined value.

5. The method of claim 1, further comprising maintaining a current number of output phases of the power outputted from the power management module when the second load is higher than the first load and is lower than a second predetermined value.

6. The method of claim 1, further comprising decreasing an operation voltage and an operation frequency of the microprocessor when the second load is less than the first load and is lower than the second predetermined value.

7. A system of power management for a motherboard, comprising:
a microprocessor;
a power management module configured to a power having a number of output phases to the microprocessor;
a detecting module configured to detect a first load of the microprocessor in a first time and to detect a second load of the microprocessor in a second time; and
a regulating module configured to reduce the number of output phases of the power outputted from the power management module when the second load is less than the first load and is lower than a first predetermined value.

8. The system of claim 7, wherein the regulating module maintain a current number of output phases of the power outputted from the power management module when the second load is less than the first load and is higher than the first predetermined value.

9. The system of claim 7, wherein the regulating module maintain a current number of output phases of the power outputted from the power management module when the second load is same as the first load.

10. The system of claim 7, wherein the regulating module increases the number of output phases of the power outputted from the power supply management module when the second load is higher than the first load and is higher than a second predetermined value.

11. The system of claim 7, wherein the regulating module maintain a current number of output phases of the power outputted from the power management module when the second load is higher than the first load and is lower than a second predetermined value.
